(19) United States
(12) Patent Application Publication
(10) Pub. No.: US 2025/0125498 A1
(43) Pub. Date: Apr. 17, 2025

(54) Retainer for fixing a busbar, housing comprising the retainer, and method for fixing a busbar, battery, and motor vehicle

(71) Applicant: Webasto SE, Stockdorf (DE)

(72) Inventors: David Schmid, Stockdorf (DE); Fabio Butani, Stockdorf (DE)

(21) Appl. No.: 18/917,005

(22) Filed: Oct. 16, 2024

(30) Foreign Application Priority Data
Oct. 16, 2023 (DE) 102023128197.6

(51) Int. Cl. H01M 50/517; H01M 50/249; H01M 50/588

(52) U.S. Cl. CPC H01M 50/517; H01M 50/249; H01M 50/588

(57) ABSTRACT

A busbar assembly for installation in a battery for a motor vehicle, comprising a housing in which at least one busbar is arranged, and a retainer for fixing the busbar in the housing, where the retainer comprises a retaining region and a contact region, wherein the retaining region is adapted to retain the at least one busbar, and the contact region is adapted to fix the retainer in the housing.

### CROSS-REFERENCE TO RELATED APPLICATION

This application claims priority to German Application No. DE 10 2023 128 197.6 filed on Oct. 16, 2023, which is incorporated herein by reference in its entirety for all purposes.

### FIELD OF THE INVENTION

The present invention relates to a retainer for fixing a busbar in a housing, to a housing comprising the retainer, and to a method for fixing a busbar in the housing, as well as to a battery and to a motor vehicle.

### BACKGROUND

It is known in the field of batteries for electrically driven motor vehicles to electrically interconnect the battery cells and battery modules by collecting conductors which are known synonymously as busbars. The busbars can be formed as rigid current guides made from a conductive metal, to be precise from sheet-metal strips, for example made from copper or aluminium. Alternatively, the busbars can be formed not only as sheet-metal strips but also as a solid-material line or as woven strips and as laminated strips. Because conductive metals such as copper or aluminium are relatively expensive and heavy, efforts are made to use them sparingly. It is thus attempted, for example, to keep the cross section of the busbars used as small as possible. One criterion that militates against reducing the cross section is the generation of heat in the busbars relative to an electrical load carrying capacity because the better the ability to dissipate the heat produced by the current flow, the smaller the cross section of the busbar can become. A cooler busbar can additionally have a lower electrical resistance, which is important from an efficiency point of view.

Thus, a busbar assembly and a method for producing a busbar assembly are known, for example, from DE 10 2013 204 825 A1.

### SUMMARY

In order to avoid inadvertent contact with the busbar and to shield the busbar from the surroundings, the busbars can be held in a half-shell or two-sided housing or be equipped with extruded insulation. The busbar must here be fixed in the housing in order to avoid noise when the motor vehicle is being driven and also vibrations which can cause damage to the busbar itself. In addition, protection against dielectric discharge to other components (for example, short-circuits, etc.) also needs to be supplied. For example, the busbar is fixed in the housing by means of a screwed connection, which is problematic in terms of sealing against liquids. In a motor vehicle, the housing must namely be leak-tight with respect to liquids. In addition, as well as absorbing the screw torque, a screwed connection must be leak-tight and have a sufficient surface area for electromagnetic compatibility (EMC) contacting. There is moreover a need to compensate for manufacturing tolerances between the busbars and the housing.

### DESCRIPTION OF THE INVENTION

Starting from the known prior art, an object of the present invention is to supply an improved retainer and a housing comprising the retainer for fixing a busbar, and a corresponding production method.

The object set above is furthermore achieved by a retainer for fixing a busbar in a housing, having the features of claim 1. Advantageous developments of the retainer can be found in the dependent claims and the present description and the figures.

Accordingly, a retainer for fixing a busbar in a housing is proposed. The retainer comprises a retaining region which is adapted to retain a busbar, and a contact region which is adapted to fix the retainer in the housing. According to the invention, a joining surface of the contact region is adapted to adhere to a correspondence joining surface of the housing or to a busbar holder arranged in the housing.

In other words, the contact region can comprise a joining surface for a bonded or glued connection via which a joined connection to the housing, for example an inner side of a housing shell, or a different structure of the housing or a busbar holder, can then be produced. For example, the contact region can also be moulded on the correspondence joining surface, in particular foamed thereon.

“Adapted to adhere” can also mean that the retainer in the contact region, in particular the joining surface, is formed from a self-adhesive plastic. As a result, no additional adhesive is necessary to form a glued connection.

The advantage consequently results that it is possible to dispense with a screwed connection between the retainer and the housing, as a result of which sealing of the housing is optionally improved. Moreover, by dispensing with the screwed connection for fixing the retainer, the number of components can be reduced and a production method thus improved. Moreover, the weight of the busbar assembly can be reduced by the use of the retainer. In addition, adaptation to manufacturing tolerances can be improved by the use of a bonded mechanical connection instead of the screwed connection.

The retainer, in particular the contact region, can have a structure comprising an elevation and/or a depression which is adapted to form a joined connection to a corresponding correspondence structure. In other words, the retainer can have, in particular in the contact region on at least one wall side facing the inner wall of the housing and/or on a busbar side facing the busbar, a structure comprising at least one elevation and/or depression which is adapted to form a joined connection to a corresponding correspondence structure comprising at least one correspondence depression and/or correspondence elevation.

The joined connection can also be a form-fitting joined connection, in particular a clamping connection. For example, the elevation can take the form of a stud and the depression the form of a sink and/or a bore which is adapted to form, with a corresponding stud and/or sink and/or bore, the joined connection, in particular the clamping connection. The advantage consequently results that stability of the bonded connection with respect to a shearing force can be improved.

Additionally or alternatively, the depression and/or the correspondence depression can take the form of a trough-like depression and/or in particular the form of a sink. The elevation and/or the correspondence elevation can be formed so that it corresponds with the trough-like depression and/or with the sink. The advantage consequently results that stability with respect to a shearing force can be improved.

Additionally or alternatively, the retaining region can have the said structure.

The retainer can comprise a plastic and/or a foam or be formed therefrom. By virtue of the design from plastic and/or foam, in addition to good formability of the functional regions, improved vibration damping can also be achieved at the same time. Furthermore, in this way reliable electrical insulation behaviour of the retainer can also be achieved.

The retainer can have a one-piece design.

The retainer, in particular the contact region, can comprise a bore and/or a slot which is designed, with a correspondence structure, in particular a corresponding correspondence elevation, to form the joined connection, wherein the elevation and/or the depression optionally comprises the hole and/or the slot. Alternatively, the slot can also take the form of a depression, in particular an elongated sink. The correspondence elevation can take the form of a stud corresponding with the slot, in particular the form of an elongated stud. The advantage consequently results that, in addition to improving the stability with respect to a shearing force, guidance in order to position the retainer in the busbar assembly is supplied.

The depression and/or the elevation can have a variable wall thickness, in particular a stepped wall thickness, in a vertical direction which is orthogonal to a longitudinal direction and a transverse direction, orthogonal to the longitudinal direction, of the busbar, wherein the depression and/or the elevation optionally comprises a bevel. In other words, a material thickness of the retainer can vary in a vertical direction in particular in the depression and/or at the elevation. The wall thickness can here decrease as the depth of the depression increases and/or the height of the elevation increases, in particular in a vertical direction, for example by means of a bevel in the depression and/or at the elevation. The advantage consequently results that the elasticity of the retainer is increased and the tolerance compensation improved.

The depression and/or the elevation can comprise, in a vertical direction, a sink and/or the bore and/or the slot, wherein the sink and/or the bore and/or the slot can have a different diameter in the vertical direction, wherein the diameter can optionally increase or decrease as the depth increases in the vertical direction. In other words, the depression and/or the sink and/or the bore and/or the slot can comprise a plurality of sinks with a different diameter in each case such that the wall thickness decreases as the depth of the depression increases in particular in the vertical direction. A stepped wall thickness corresponding to the diameter is thus achieved. As a result, the wall thickness of an elevation situated on a different side from the depression, in particular a spacer, also decreases correspondingly, as a result of which a stepped decrease in the wall thickness is achieved. The advantage consequently results that the elevation can be pressed in telescopically, whereby elasticity of the retainer is further increased for improved tolerance compensation.

The joining surface can be arranged in the depression and/or on the elevation and optionally comprise the sink and/or the bore and/or the slot. In other words, the correspondence joining surface can be arranged on a corresponding correspondence elevation and/or correspondence depression such that, for joining the retainer, the respective elevation and/or depression can be joined into the corresponding correspondence depression and/or onto the correspondence elevation for the formation of a joined connection. The joined connection can optionally take the form of a clamping connection. The advantage consequently results that stability with respect to a shearing force is further improved.

The retainer can, in particular in the retaining region, comprise a spacer which is formed as a single piece with the retainer or at least from a material which is different from the retainer, in particular a more elastic material than a material of the retainer, wherein the spacer can optionally have a contact shape and/or a cavity and can be adapted to press against the busbar for fixing it. In other words, the spacer can take the form of an elevation of the retainer and optionally comprise at least one bevel. The spacer, in particular the contact shape, can have a wedge shape or a pyramid shape. Optionally, the spacer and/or the contact shape can have a tip, in particular a rounded tip, by means of which it can press against an upper surface, in particular a depression, corresponding with the tip, in the upper surface of the busbar. The material can be, for example, a plastic.

As an alternative to a cavity, the spacer can have, on the side of the busbar opposite the retainer, a depression, corresponding with the spacer, on the wall side of the retainer, as a result of which the wall thickness of the retainer is reduced. The depression can optionally have a bevel, as a result of which the elasticity of the spacer is further increased.

The retainer can comprise at least two spacers in particular in the retaining region in the longitudinal direction of the busbar, wherein the spacers are separated in the longitudinal direction by means of a gap and the gap is optionally filled with a heat-dissipating medium. In other words, the spacer can have in the longitudinal direction the gap or an interruption which is optionally filled with the heat-dissipating medium. The advantage consequently results that heat dissipation from the busbar in the busbar assembly is further improved.

The retainer can have a slope in the vertical direction with respect to a plane in the transverse direction and/or the retaining region can have a thinner wall thickness than the contact region, in particular in the transverse direction. In other words, in the plane with respect to the transverse direction, the retainer can have a wave shape which optionally comprises the slope or an offset. The slope can here comprise an inclination and/or an offset of the retainer, in particular in the vertical direction. The advantage consequently results that busbars of different sizes can be fixed by the retainer.

The object is furthermore achieved by a housing having the features of claim 10. Advantageous developments can be found in the subclaims, the description and the figures.

Accordingly, a housing for a busbar is proposed which comprises a retainer for fixing the busbar. The retainer comprises a retaining region and a contact region, wherein the retaining region is adapted to retain the at least one busbar and the contact region is adapted to fix the retainer in the housing.

According to the invention, the contact region of the retainer has a joining surface and the retainer is joined at the joining surface onto a corresponding correspondence joining surface of the housing and/or on a busbar holder, arranged in the housing, for fixing the busbar and/or adheres to the correspondence joining surface of the housing by means of the joining surface.

In other words, the contact region of the retainer can have a joining surface and the retainer can be joined and/or glued at the joining surface to the corresponding correspondence joining surface of the housing, for example on the inner side of the housing and/or on a busbar holder, arranged in the housing, for fixing the busbar.

Additionally or alternatively, the retainer can be moulded, in particular foamed, onto the correspondence joining surface of the inner side and/or of the busbar holder and optionally on the busbar. Optionally, electrical insulation, in particular by the retainer, can be supplied between the busbar and the inner wall of the housing.

The retainer can here, as part of a degassing concept, be arranged and configured such that targeted guidance of the gases is achieved in the event of propagation of the battery, i.e. in the case of thermal runaway of one or more battery cells. For this purpose, the retainer can be adapted to form a gastight joined connection to the correspondence joining surface, in particular a correspondence structure of the correspondence joining surface, and/or to surround the respective busbar at least partially gastightly. Gas-guidance structures can furthermore also be incorporated.

The busbars can take the form of sheet-metal strips, preferably copper sheet-metal strips and/or aluminium sheet-metal strips. The housing can have a half-shell or two-sided design. In the two-sided variant, the housing has a bottom shell and a top shell which are joined to each other to form the housing and are optionally connected to each other by means of a connecting element. By connecting the top shell and bottom shell, the retainer can be pressed against the inner side and/or the busbar holder and/or the busbar by means of mechanical tension. The connecting element can be a welded, soldered, riveted, screwed and/or glued connection.

The retainer can take the form of a hold-down device. The retaining region of the retainer and/or of the busbar holder can, for example, comprise a receptacle which is formed so that it is smaller by a predetermined amount than a width of the respective held busbar. The retaining region of the busbar holder can be delimited by a rib which can optionally comprise the correspondence joining surface. As a result, a clamping action on the busbar can be obtained in order to fix it. The retainer and/or the busbar holder can surround the respective busbar in a peripheral direction of its cross section orthogonally to its longitudinal extent at least on three sides, in particular completely.

The “surrounding” described herein of the busbars by the retainer and/or by the busbar holder can be adherent surrounding in which at least a plastic of the retainer and/or the busbar holder permanently adheres by means of the joining surface to the correspondence joining surface and optionally to an outer surface of the respective busbar in the retaining region, in particular by means of the receptacle and/or by means of a spacer.

The retainer and/or the busbar holder can comprise at least a plastic, in particular consisting of an elastomer and/or a thermoplastic elastomer, or be formed therefrom. The retainer can be formed as a single piece.

Additionally or alternatively, the retainer can be formed from at least one foam body, in particular comprising a plastic foam, for example a polyurethane foam. The foam body can optionally have a density of 0.5 to 1.5 kg/dm³, in particular of 0.8 to 1.2 kg/dm³. The plastic of the retainer, in particular the foam body, can have a Shore A hardness of 60 to 100, in particular a Shore A hardness of 80 to 90, and/or a flammability rating of UL94 V0 or UL94 HB. In this way, the retainer can have an elastic design and thus optionally provide vibration damping. The retainer can be moulded, in particular injection-moulded and/or foamed, at least on the inside of the housing and/or the foam body and optionally the busbar.

The term “moulded (on)” or “moulding (on)” is defined here as adhesion, during a flowable state during shaping, for example injection-moulding or casting, of the retainer, of the adhesive and/or reactive plastic material to the upper surface, in particular the correspondence joining surface, of an adhesion partner, for example to the upper surface of the respective busbar and/or the inside of the housing and/or of the busbar holder.

The term “foaming (on)” or “foamed (on)” is defined here as adhesion, which is created during a foaming process of a plastic foam, of the reactive foam material to the upper surface of an adhesion partner, in particular of the correspondence joining surface. Accordingly, in a foaming process for forming the retainer in the form of a foam body by virtue of the adhesive action of the reactive foam during the foaming, the foam can here be permanently adherently connected to the inside of the housing and/or the busbar holder and optionally the respective busbar. There is thus no gluing step with an additional glue. There can thus be no additional layer of glue between the foam material of the foam body and the respective correspondence joining surface. Instead, the foam body, in particular the retainer, can adhere optionally with the joining surface directly to the respective correspondence joining surface. “Foaming (on)”, as well as “injection moulding” and “overmoulding” therefore constitute a form of “moulding”.

The joining surface and/or the correspondence joining surface can have been subjected to a pretreatment, for example cleaning or roughening, in advance. An adhesion promoter or an adhesion-promoting layer, in particular a primer, can be applied to the joining surface and/or the correspondence joining surface.

The advantage consequently results that it is possible to dispense with a screwed connection between the retainer and the housing, as a result of which sealing of the housing can optionally be improved. Moreover, by dispensing with the screwed connection for fixing the retainer, the number of components can be reduced and a production method improved. Moreover, the weight of the busbar assembly can be reduced by the use of fewer components. In addition, adaptation to manufacturing tolerances can be improved by the use of a bonded mechanical connection instead of the screwed connection.

The retainer can, in particular in the contact region, have a structure which comprises an elevation and/or a depression and can, with a correspondence structure which is arranged on the inner side of the housing and/or on the busbar holder, corresponds with the structure of the retainer and comprises a corresponding correspondence elevation and/or correspondence depression, form a joined connection. In other words, the structure of the retainer can be joined into the correspondence structure on the inside of the housing and/or into the correspondence structure of the busbar holder. The elevation and/or depression can be adapted to form in each case a joined connection, in particular a form-fitting joined connection, with the correspondence depression and/or correspondence elevation. For example, the joined connection can be a clamping connection. The structure and/or the correspondence structure can thus be adapted to form the joined connection.

For example, the elevation and/or the correspondence elevation can take the form of a stud and the depression and/or the correspondence depression can take the form of a sink which can hold the stud. The advantage consequently results that a shearing force can be counteracted and thus the stability of the busbar assembly improved.

Additionally or alternatively, the retaining region can have the structure and optionally an upper surface of the busbar can have the correspondence structure.

The retainer and optionally the elevation and/or the depression can comprise a bore and/or a slot in particular in the contact region which, with the correspondence structure, in particular with the corresponding correspondence elevation, can form the joined connection. Alternatively, the retainer can comprise an elongated sink or the depression instead of a slot. The structure of the retainer can have a sink and/or a bore which, with a corresponding stud, in particular an elongated stud, of the correspondence structure, can form a joined connection. Additionally, the sink and/or the bore can optionally, together with the stud of the correspondence structure, form a guide when positioning the retainer. The advantage consequently results that a shearing force can be counteracted and a positioning aid supplied.

The depression and/or the elevation can have a variable wall thickness, in particular a stepped wall thickness, in a vertical direction which is orthogonal to a longitudinal direction and a transverse direction, orthogonal to the longitudinal direction, of the busbar, wherein the depression and/or the elevation optionally comprises a bevel. The advantage consequently results that the elasticity of the retainer is increased for improved tolerance compensation.

Additionally or alternatively, the depression and/or the elevation can comprise, in the vertical direction, a sink and/or the bore and/or the slot, wherein the sink and/or the bore and/or the slot has a different diameter in the vertical direction, wherein the diameter optionally increases or decreases as the depth increases in the vertical direction. A stepped wall thickness can thus be achieved which increases or decreases in the vertical direction. The advantage consequently results that the elasticity of the retainer is further increased for improved tolerance compensation. The sink and/or the bore and/or the slot of the structure can hold a corresponding stud of the correspondence structure for a form-fitting joined connection. The advantage consequently results that the stability with respect to a shearing force can be further improved.

The correspondence joining surface can be arranged in the correspondence depression and/or the correspondence elevation and comprise in each case optionally the sink and/or the bore and/or the slot.

Additionally or alternatively, the joining surface of the retainer can be arranged in the depression and/or on the elevation and comprise in each case optionally the sink and/or the bore and/or the slot.

The advantage consequently results that the stability with respect to a shearing force can be further improved.

The retainer can comprise in the retaining region a spacer which is formed as a single piece with the retainer or at least from a different material from the retainer, in particular a more elastic material than a material of the retainer, wherein the spacer optionally has a contact shape and/or a cavity and is adapted to press the busbar against the inside of the housing and/or the busbar holder. In other words, the spacer can be formed from the same plastic as the retainer, wherein the spacer can take the form of an elevation. The contact shape of the spacer can be adapted to adapt in particular in form-fitting fashion to the busbar and/or to retain the busbar under mechanical tension.

For example, the spacer can, in particular by means of the contact shape, be designed, on the one hand, to adapt to the busbar and, on the other hand, to retain the busbar under temperature and dynamics under mechanical tension.

For example, the contact shape of the spacer can be a wedge shape or a pyramid shape. The material can, for example, be a plastic. The advantage consequently results that the elasticity of the retainer is improved when fixing the busbar.

Additionally or alternatively, the spacer can have a rounded tip and/or a bevel, wherein the spacer presses against the busbar in particular with the tip on an upper surface, in particular in a depression, corresponding with the tip, on the upper surface of the busbar. The advantage consequently results that the elasticity of the retainer is further improved.

As an alternative to the cavity, the retainer can have, on a busbar side of the retainer on an opposite wall side of the retainer with respect to the spacer, a corresponding depression in the retaining region such that a wall thickness in the region of the spacer and/or the elevation is reduced. The retainer can thus also have the depression in the retaining region. The advantage consequently results that the elasticity of the retainer is further improved.

Additionally or alternatively, the spacer can comprise at least two spacers in particular in the retaining region in the longitudinal direction of the busbar, wherein the spacers are separated in the longitudinal direction by means of a gap and the gap is optionally filled with a heat-dissipating medium. In other words, the spacer can have in the longitudinal direction the gap which is optionally filled with the heat-dissipating medium. The advantage consequently results that thermal conductivity is improved in addition to the elasticity.

The retainer can have a slope in the vertical direction with respect to a plane in the transverse direction, and/or the retainer can in the retaining region optionally have a thinner wall thickness in the transverse direction than in the contact region. In other words, the retainer can have, in the plane in the transverse direction, a wave shape which comprises in particular the slope. In contrast to the elevation and/or the depression, the slope can take the form, for example, of an inclination of a body of the retainer and/or an offset of the body in particular in the vertical direction. The advantage consequently results that the retainer can be adapted to busbars of different sizes.

The object set above is furthermore achieved by a battery or a battery system comprising the said busbar assembly and/or the said retainer. The battery or the battery system can take the form of a primary drive battery of a motor vehicle which can deliver (high-voltage) power for an electric motor of the motor vehicle in particular as a primary drive. The battery system can be formed as an electrical interconnection of a plurality of battery packs which comprise in each case a plurality of battery cells.

The object set above is furthermore achieved by a motor vehicle comprising the said battery or the said battery system. The motor vehicle can preferably be configured as in particular a car or lorry, or a minibus or motorcycle. The motor vehicle can be electrically driven (EV) or in particular be a hybrid electric vehicle (HEV, PHEV), wherein the components in the motor vehicle which are provided for this can in each case be an electrical consumer of the battery or the battery system.

The object set above is furthermore achieved by a method for fixing a busbar having the features of claim 15 or claim 16. Advantageous developments of the method can be found in the subclaims and this description and the figures.

Accordingly, a method for fixing at least one busbar by means of a retainer, in particular the abovementioned retainer, is proposed, comprising the steps:
moulding, in particular foaming, the retainer onto a correspondence joining surface of the housing and/or onto a correspondence structure on an inner side of the housing and/or onto a busbar holder in the housing;
arranging the at least one busbar in the housing and fixing it by means of the retainer.

Accordingly, a method for fixing at least one busbar by means of a retainer, in particular the abovementioned retainer, is furthermore proposed, comprising the steps:
arranging the at least one busbar in the housing and/or on a busbar holder arranged in the housing;
applying a glue to a joining surface of the retainer and/or to a correspondence joining surface of the housing and/or on a busbar holder;
joining the joining surface of the retainer to the correspondence joining surface;
fixing the at least one busbar in the housing by means of the retainer.

In other words, the plastic can be a foam. The busbar assembly can comprise the housing and at least one busbar as well as optionally the retainer. The housing can be the abovementioned housing and/or the retainer can be the abovementioned retainer. The retainer, in particular the foam, can be moulded, in particular foamed, against a correspondence structure on the inner side of the housing and/or on the busbar holder and optionally against an upper surface of the busbar. As a result, the structure, corresponding with the correspondence structure, of the retainer can be formed by means of moulding the plastic, in particular foaming the foam, onto the correspondence structure.

The retainer can be joined at the joining surface to the correspondence joining surface by assembling the top shell and the bottom shell, and optionally be pressed by a mechanical tension supplied by the top shell and bottom shell against the correspondence joining surface and/or against the inner side of the housing and/or the busbar holder and optionally the busbar in order to fix the busbar.

The advantage consequently results that a screwed connection for fixing the retainer in the housing can be dispensed with, wherein stability with respect to a shearing force on the retainer is improved in addition. Additionally, adaptation to tolerances is improved by the elasticity of the retainer.

Optionally, after the moulding, in particular foaming, of the retainer on a busbar side, facing the busbar, of the retainer, a spacer can be arranged on the retainer.

In other words, the retainer can be pressed against the inner side of the housing and/or against the busbar holder by a mechanical tension created when the top shell and bottom shell are joined to each other, against the correspondence joining surface and optionally against an upper surface of the busbar, in order to fix the busbar. The housing can be the abovementioned housing and/or the retainer can be the abovementioned retainer. The busbar can be arranged in the housing optionally with electrical insulation against the inner side of the housing, which electrical insulation is supplied additionally or alternatively by the retainer comprising at least a plastic. Optionally, the retaining region of the retainer can be joined to the busbar during the joining of the retainer. Optionally, the spacer can be joined against a depression on the upper surface of the busbar. The advantage consequently results that a screwed connection for fixing the retainer in the housing can be dispensed with, wherein in addition adaptation to manufacturing tolerances by the elasticity of the retainer and the joined connection is improved.

The invention also comprises implementations which comprise a combination of the features of several of the embodiments described. Optionally, the busbar assembly described and/or the retainer can have structural features from the method, and vice versa.

### BRIEF DESCRIPTION OF THE FIGURES

Preferred further embodiments of the invention will be explained in detail by the following description, in which:

FIG. 1 shows schematically a plan view of the busbar assembly from above;

FIG. 2 shows schematically a section through the busbar assembly;

FIG. 3 shows schematically a perspective view of a first embodiment of the retainer;

FIG. 4 shows schematically a plan view of the first embodiment of the retainer;

FIG. 5 shows schematically a perspective view of a second embodiment of the retainer;

FIG. 6 shows schematically a plan view of the second embodiment of the retainer;

FIG. 7 shows a schematic illustration of a first embodiment of the production method of the busbar assembly; and

FIG. 8 shows a schematic illustration of a second embodiment of the production method of the busbar assembly.

### DETAILED DESCRIPTION

Preferred exemplary embodiments will be described below on the basis of the figures. Elements which are the same, are similar or have the same action are provided here in the different figures with identical reference signs and in some cases repeated description of these elements will be dispensed with in order to avoid redundancies.

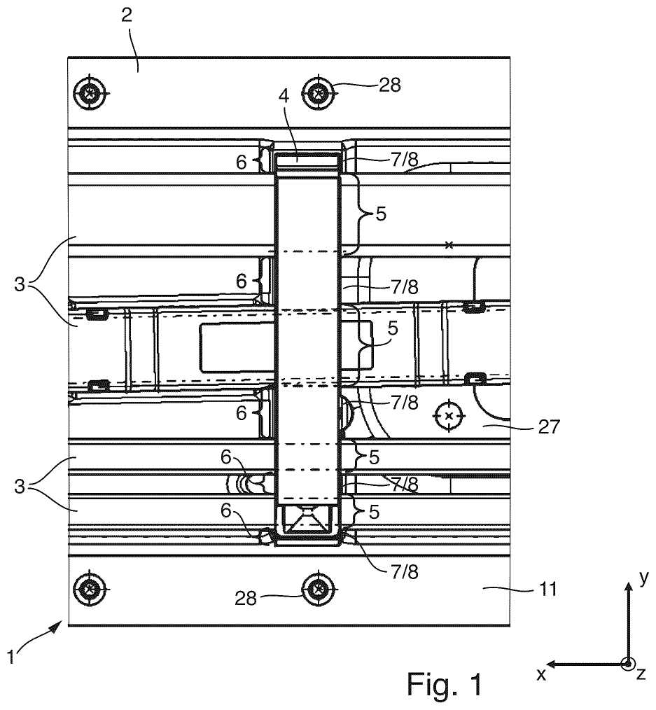

Illustrated schematically in FIG. 1 is a plan view of the busbar assembly 1, in a battery, which comprises the housing 2 in which at least one busbar 3 is arranged in the longitudinal direction x. The busbar 3 can take the form of a metal cuboid in the longitudinal direction x and transverse direction y which forms the current-carrying element or in which is arranged at least one current-carrying element for electrically connecting the battery cells of the battery, such as for example a cable. The housing 2 comprises a bottom shell 11 and a top shell (not shown) which are joined to each other in order to close the housing 2 and are held against each other by means of the screwed connection 28. In order to fix the busbar 3 in the housing 2, in particular in the bottom shell 11, a retainer 4 is inserted into the housing 2, in particular into the bottom shell 11 or into the top shell (not shown).

The retainer 4 can comprise at least a plastic, in particular an elastomer, or be formed therefrom and comprise a contact region 6 for fixing the retainer 4 in the housing 2, and a retaining region 5 for retaining the busbar 3. The contact region 6 can comprise, for example, a joining surface 7 which can be configured in particular as an adhesion surface for a bonded or glued connection. In particular, the joining surface 7 can comprise a self-adhesive plastic.

In the contact region 6, the retainer 4 is joined, in particular glued, at the joining surface 7 to a corresponding correspondence joining surface 8 on the inner side 27 of the housing 2, in particular of the bottom shell 11, and/or onto a corresponding correspondence joining surface 8 of a busbar holder (not illustrated) arranged in the housing 2.

The correspondence joining surface 8 can likewise take the form of a correspondence adhesion surface. The joining surface 7 and/or the correspondence joining surface 8 and/or a surface of the busbar 3 can in advance be subjected to a pretreatment, for example cleaning or roughening. Optionally, an adhesion promoter or an adhesion-promoting layer, in particular a primer, can be applied.

Alternatively, the retainer 4 can be moulded or foamed onto the correspondence joining surface 8 and optionally onto a busbar 3 arranged in the housing 2. The retainer 4 is thus connected at the joining surface 7 and at the correspondence joining surface 8 permanently adherently to the inner side 27 of the housing 2 and/or the busbar holder (not illustrated) and optionally the busbar 3.

The contact region 6 optionally has a structure (not illustrated) which, by means of a corresponding correspondence structure (not shown), improves resistance to a shearing force.

The retaining region 5 of the retainer 4 is adapted to retain at least one busbar 3, for example by pressing by means of a spacer (not shown) against the inner side 27 and/or the respective busbar holder (not shown).

Additionally or alternatively, the retaining region 5 of the retainer 4 can be adapted to hold at least a part of the busbar 3 or at least a part of in each case at least one busbar 3. Additionally, the retainer 4, in particular the retaining region 5, can be moulded, in particular injection-moulded and/or foamed, onto the busbar 3. Additionally, the retainer 4 can be moulded, in particular injection-moulded and/or foamed, on the inner side 27 of the housing 2, in particular a top shell or bottom shell, and/or on the busbar holder (not shown).

Additionally, the retaining region 5 can surround the busbar 3 in a peripheral direction of its cross section in the longitudinal direction x at least on three sides. “Surround” can here mean “adherently surround”, where the material of the retainer 4, in particular the elastomer, permanently adheres to an outer surface of the busbar 3.

Additionally, the retaining region 5 can completely surround the busbar 3 in the peripheral direction of its cross section in the longitudinal direction x, wherein a surface facing away from the busbar 3 can be used as an optional joining surface 7.

By virtue of the use of the gluing or moulding of the retainer 4 onto the inside 27 of the housing 2 and/or the busbar holder in order to fix the retainer 4, an independent screwed connection 28 by means of which the retainer 4 could be fixed in the housing 2, can be dispensed with. Sealing of the housing 2 can be improved by dispensing with an independent screwed connection for fixing the retainer 4 in the housing 2. Additionally, the elasticity of the retainer for compensating manufacturing tolerances can be improved.

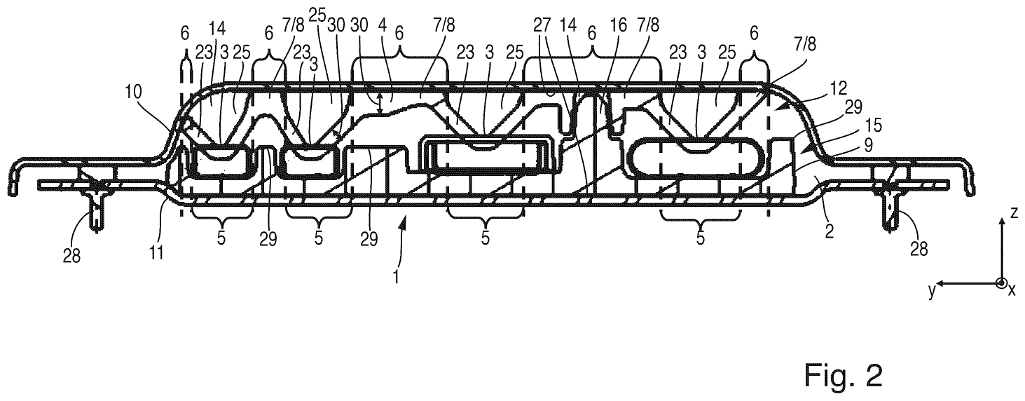

FIG. 2 shows schematically a section through the busbar assembly 1 in the longitudinal direction x. The housing 2 comprises a top shell 10 and a bottom shell 11 which are connected to each other by means of the screwed connection 28 and form the housing 2. In the housing 2, the busbar holder 9 is arranged on the bottom shell 11 and the retainer 4 is arranged on the top shell 10. The busbar 3 is arranged on the busbar holder 9 which has a retaining region 5 for holding at least one busbar 3. In each case at least one busbar 3 can be arranged here in the retaining region 5 of the busbar holder. Additionally, the busbar holder 9 can be glued onto the inner side 27 of the housing 2, in particular the bottom shell 11 or top shell 10. Additionally of alternatively, the busbar holder can be fixed in the housing 2 between the top shell 10 and the bottom shell 11 by means of the screwed connection 28.

The retaining region 5 of the busbar holder 9 can take a similar form to the retaining region 5 of the retainer 4. Additionally, the busbar holder 9, in particular the retaining region 5, comprises a rib 29 for retaining the busbar 3. The busbar 3 is here arranged in the retaining region 5 in the peripheral direction of its cross section in the longitudinal direction x on in each case two opposite sides on in each case one rib 29 for fixing it.

The retainer 4 is arranged on an inner side 27, opposite the busbar holder 9, of the housing 2. The retainer 4 is, for example, glued or moulded onto the inner side 27. The retainer 4 presses by means of the contact region 6 against the busbar holder 9, in particular the rib 29, whilst the retaining region 5 presses against an upper surface of the busbar 3 by means of the spacer 23.

Optionally, the contact region 6 of the retainer 4 can have a thicker wall thickness 30 than the retaining region 5, or the contact region 6 can have a thinner wall thickness 30 than the retaining region 5. In addition, the retainer 4 can have a combination of the said thicker and thinner wall thickness 30 of the contact region 6.

The retainer 4 comprises, in particular in the contact region 6, a structure 12 which is formed at least from an elevation 13 and/or a depression 14 and which is configured to be joined to a correspondence structure 15 of the busbar holder 9 and/or alternatively of the inner side 27 of the housing. The correspondence structure 15 is likewise formed from at least one correspondence elevation 16 and/or one correspondence depression (not illustrated). For example, the correspondence elevation 16 can take the form of a stud which, with the depression 14 of the retainer 4 which can take the form of a sink, forms a joined connection, in particular a clamping connection. The correspondence elevation 16 can therefore be inserted into the depression 14. This further improves stability with respect to a shearing force.

The retainer 4 has in the retaining region 5 a spacer 23 which is designed for retaining the busbar 3. The spacer 23 is adapted to be seated on an upper surface of the busbar 3 and press against it for fixing the busbar 3. The spacers are thus illustrated in FIG. 2 in a starting position in which they are not pressed against the respective busbar 3. Tips of the spacers 23 are thus situated, by way of example, below an upper side of the busbars 3. The spacer 23 can optionally have a cross section which changes in a vertical direction z. The spacer 23 can have a smaller cross section on a side facing away from the retainer 4 than on a side facing the retainer 4. For example, the spacer 23 can be formed with a wedge shape or pyramid shape, which increases elasticity.

Additionally or alternatively, the spacer 23 can have a cavity 25 which further increases elasticity. Additionally, the spacer 23 can be formed from an elastomer which is optionally different from the elastomer of the retainer 4, in particular is softer than it.

Alternatively, the retainer 4 can have, on a side opposite the spacer 23, in particular in the vertical direction z, a depression 14 which is situated opposite the spacer 23 and can be formed with a similar shape to the spacer 23. Elasticity of the spacer 23 can be improved as a result.

The retainer 4 can be pressed against the busbar 3 by means of a mechanical tension of the housing 2. For example, the pressure for the retainer 4 to fix the busbar 3 can be supplied by the screwed connection 28 which mechanically connects the top shell 10 to the bottom shell 11.

For this purpose, the retainer 4 can be formed according to a first and a second embodiment which are shown in detail in the following figures.

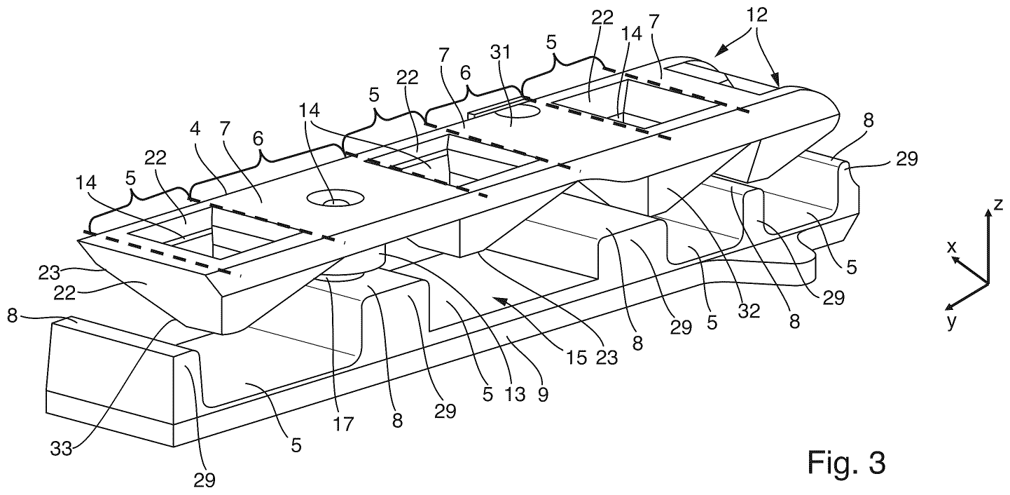

FIG. 3 shows schematically a perspective view of the first embodiment of the retainer 4. The retainer 4 has the retaining region 5 and the contact region 6 on a wall side 31 and a busbar side 32. The retaining region 5 and/or the contact region 6 have, on the wall side 31 and/or the busbar side 32, a structure 12 comprising at least one elevation 14 and/or one depression 14, wherein the structure 12 corresponds on the busbar side 32 with the correspondence structure 15 for forming a joined connection.

The retaining region 5 of the busbar holder 9 can here be formed so as to hold at least one busbar 3. The retaining region 5 has, on the wall side 31, a depression 14 opposite the spacer 23 on the busbar side 32 and which can optionally be formed with a similar shape to the elevation 13 situated opposite. This increases elasticity of the elevation 13 on the busbar side 32 of the retainer 4 which is formed in particular as a single piece with the retainer 4. The spacer 23 is adapted to press on an upper surface of a busbar 3 in particular by means of the tip 33 in order thus to fix the busbar 3 in the busbar holder 9. The spacer 23 is formed, for example, with a wedge shape or pyramid shape.

Additionally or alternatively, the spacer 23 and/or the elevation 13 and/or the depression 14 have a bevel 22. Elasticity of the spacer 23 can be further improved as a result.

In the contact region 6, the retainer 4 has the joining surface 7 and optionally the depression 14 on the wall side 31 and/or the busbar side 32. At the joining surface 7, the retainer 4 is joined on the wall side 31 to the inner wall 27 of the housing 2, wherein the joining surface 7 optionally takes the form of an adhesion surface for a bonded or a glued connection. The depression 14 can optionally have a sink and/or a bore. In particular, the bore can be arranged in the sink. Opposite the depression 14, the retainer 4 can have an elevation 13 in the contact region 6, in particular on the busbar side 32. The elevation 13 can be formed, for example, with a cylinder shape or cuboid shape. Additionally, the elevation 13 can take the form of a stud. The elevation 13 corresponds with the correspondence depression 17 of the busbar holder 9 such that the elevation 13 can be joined into the correspondence depression 17 for forming a joined connection, in particular a clamping connection. The correspondence depression 17 can optionally take the form of a sink. The elevation 13 and the correspondence depression 17 in each case comprise the joining surface 7 and the correspondence joining surface 8.

In addition, the elevation 13 can comprise a sink and the correspondence depression 17 a corresponding stud such that the elevation 13 latches into the correspondence depression 17.

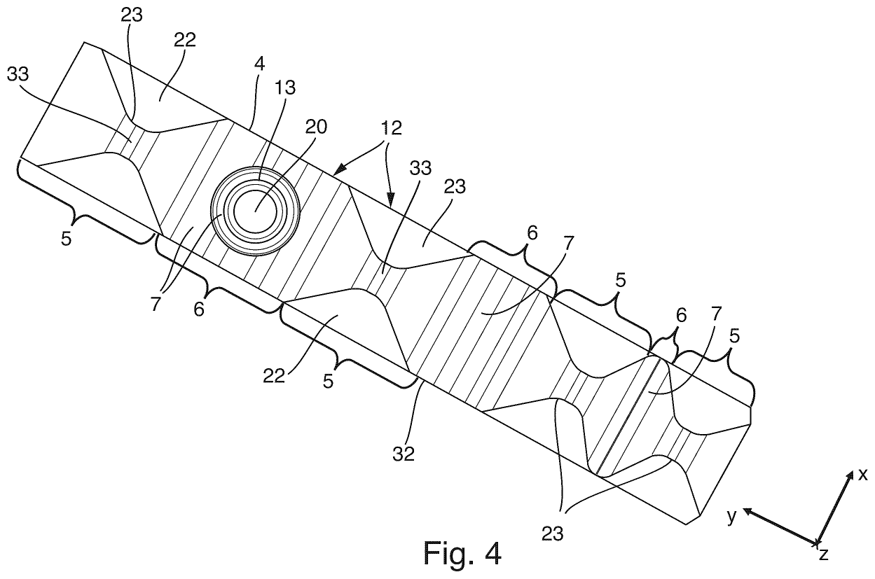

FIG. 4 shows schematically a plan view of the busbar side 32 of the first embodiment of the retainer 4 which has the structure 12. The retaining region 5 can here be adapted to press on at least one busbar 3 optionally by means of a spacer 23 for fixing the busbar 3. The spacer 23 in the retaining region 5 is formed as a single piece with the retainer 4. The spacer 23 additionally has a bevel 22 such that it is formed with a wedge shape or pyramid shape, which improves elasticity. Optionally, the spacer has a tip 33. When the retainer 4 is arranged on the busbar holder 9, the tip 33 of the spacer 23 presses in the vertical direction z against an upper surface, in particular against a depression arranged on the upper surface, of the busbar 3 such that the latter is fixed in the busbar holder 9.

The contact region 6 has the joining surface 7 on the busbar side 32. Additionally or alternatively, the contact region 6 has the elevation 13 which additionally comprises the joining surface 7. The elevation 13 additionally has the sink 20 which alternatively takes the form of a bore. Elasticity can be improved as a result. The elevation 13 can be joined into a correspondence depression 17 of the busbar holder 9 and/or the sink 20 can be joined onto a correspondence elevation 16 of the busbar holder 9. A shearing force can be better counteracted as a result.

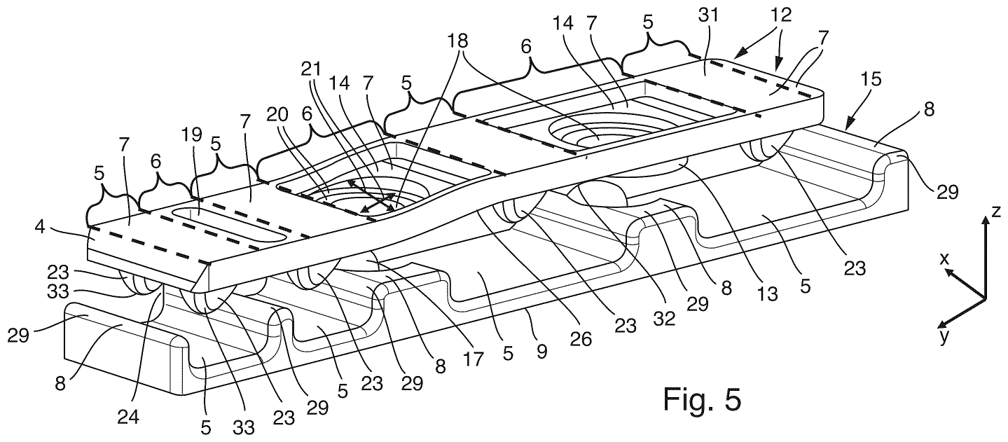

FIG. 5 shows schematically a perspective view of a second embodiment of the retainer 4. Reference should be made to the above description of FIGS. 3 and 4 for features which are common to the second embodiment and the first embodiment of the retainer 4.

In contrast to the first embodiment, in the second embodiment the retainer 4 has a structure 12, comprising a slot 19 and/or a depression 14 in particular in the contact region, which optionally comprises a sink 20 and a bore 18 with in each case different diameters.

The contact region 6 has a slot 19 which is adapted to be joined onto a corresponding correspondence elevation 16 on the busbar holder 9 and/or the inside 27 of the housing. The correspondence elevation 16 can be, for example, a corresponding stud or the rib 29 of the busbar holder 9 optionally comprising the correspondence elevation 16. Guidance can consequently be supplied when positioning the retainer 4. Alternatively, the slot 19 can also take the form of an elongated sink.

Additionally, the contact region 6 has, in particular on the wall side 31, a depression 14 which comprises the joining surface 7. Additionally, the depression 14 and/or the joining surface 7 has at least one sink 20 with an optionally varying, in particular decreasing, diameter 21.

Additionally, the sink 20 can comprise a bore 18. In addition, the retainer 4 can have, in the contact region opposite the depression 14, in particular on the busbar side 3, an elevation 13 corresponding with the depression. When the elevation 13 is pressed against the correspondence depression 17 onto the busbar holder 9, it can thus be pressed in gradually, for example telescopically. This improves elasticity for tolerance compensation. Moreover, a shearing force can be better counteracted when the depression 14 and/or the elevation 13 and/or the sink 20 and/or the bore 18 are joined onto the corresponding correspondence elevation 16 and/or correspondence depression 17. Additionally, the retainer 4 can be latched to the busbar holder 9 by means of the sink 20 and/or the bore 18.

In contrast to the first embodiment, the second embodiment has in the retaining region 5 in the longitudinal direction x at least two spacers 23 which are separated from each other by the gap 24. The spacers 23 can here be formed from a different elastomer than the retainer 4. For example, the spacer 23 can be formed from a more elastic elastomer and/or an elastomer with a better thermal conductivity than the retainer 4. Additionally, the gap 24 can be filled with a heat-conducting medium. The spacers 23 are here adapted to press against the busbar 3 with the tip 33 and thus to fix the latter in the retaining region 5 between the ribs 29 of the busbar holder 9. The spacer 23 can be formed, for example, with a wedge shape or pyramid shape, wherein optionally the tip 33 can be rounded.

Additionally or alternatively, the respective spacer 23 can comprise a cavity 25 which further increases elasticity.

Additionally, the retainer 4 can have a slope 26 such that the retainer 4 can lie on the busbar side 32 on busbars 3 of different sizes. The slope 26 can take the form of an inclination of the retainer 4 and optionally have a wave shape.

Additionally, the retaining region 5 can be adapted to press by means of at least one spacer 23 against in each case one busbar 3 in the retaining region 5 for fixing the busbar 3.

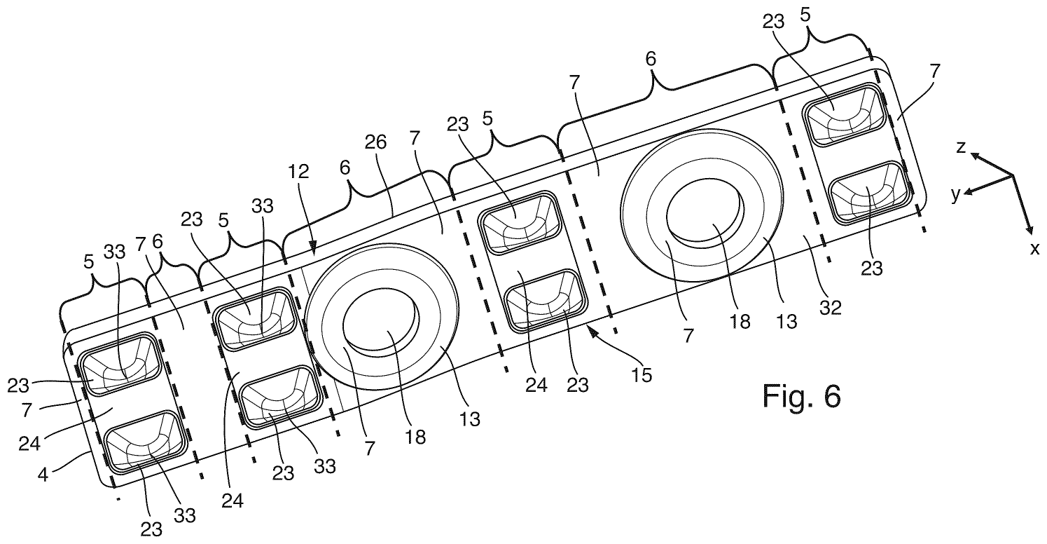

FIG. 6 shows schematically a plan view of the busbar side 32 of the second embodiment of the retainer 4. The contact region 6 has an elevation 13 which is optionally situated opposite the depression on the wall side 31 of the retainer 4. Additionally, the elevation 13 can have a correspondence shape corresponding with the shape of the depression. The elevation 13 optionally comprises the bore 18, wherein the elevation 13 and/or the bore 18 are joined onto a corresponding correspondence elevation 16 and/or correspondence depression 17 of the busbar holder and/or the inner side 27 of the housing. Additionally, the elevation 13 has the joining surface 7. As a result, guidance when positioning the retainer 4 in the housing 2 can be supplied and additionally a shearing force can be better counteracted. For common features, reference should be made in each case to FIGS. 3 to 5.

Additionally, the contact region 6 has on the busbar side 32 a joining surface 7 which is joined onto a correspondence joining surface 8 on the busbar holder 9. Additionally, the joining surface 7 and/or the correspondence joining surface 8 can be provided as an adhesion surface for a glued connection.

The retaining region 5 has, in the longitudinal direction x, at least two spacers 23 which are separated by the gap 24 and are adapted to press with the tip 33 in the vertical direction z against a busbar 3 in order to fix the latter in the busbar holder 9.

Additionally, the retainer 4 has the slope 26 which is adapted to adapt the retaining region 5 to busbars 3 of different sizes.

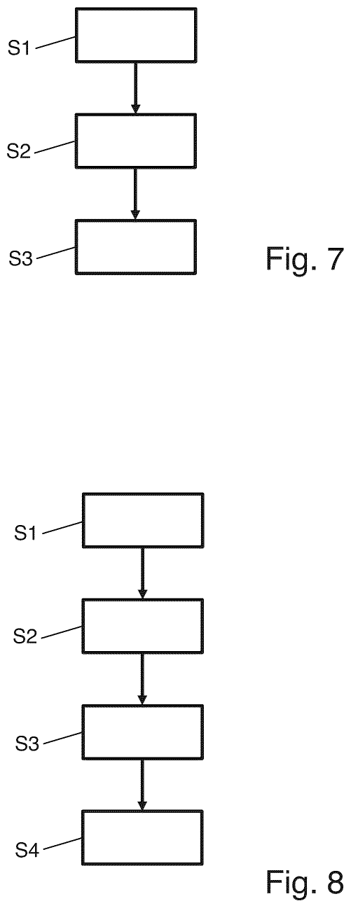

FIG. 7 shows a schematic illustration of a first embodiment of the production method of a busbar assembly 1. In a first step S1, a busbar 3 is arranged in a housing 2 of the busbar assembly 1, in particular in a top shell 10 or a bottom shell 11, and/or on a busbar holder 9 arranged in the housing 2, in particular in the top shell 10 or in the bottom shell 11.

In a second step S2, the retainer 4 which is formed at least from a plastic or an elastomer is moulded, in particular foamed, onto a correspondence joining surface 8 on the inner side 27 of the housing 2, in particular of the top shell 10 or the bottom shell 11, and/or on the busbar holder 9 and optionally on an upper surface of the busbar 3.

Additionally or alternatively, in the second step S2 the retainer 4 is moulded or foamed against a correspondence structure 15, on the inner side 27 and/or on the busbar holder 9, which optionally comprises the correspondence joining surface 8.

In a supplementary third step S3, the top shell 10 and the bottom shell 11 are assembled to form the housing 2. As a result, the retainer 4 is optionally pressed against the busbar holder 9 by means of a mechanical tension created when the top shell 10 and the bottom shell 11 are joined together such that the respective busbar 3 is fixed in the housing 2 and/or the busbar holder 9 by means of the spacer 23.

FIG. 8 shows a schematic illustration of a second embodiment of the production method of the busbar assembly 1.

In a first step S1, a busbar 3 is arranged in the housing 2 of the busbar assembly 1, in particular in the top shell 10 or in the bottom shell 11, and/or on the busbar holder 9 arranged in the housing 2, in particular in the top shell 10 or in the bottom shell 11.

In an optional second step S2, a glue is applied to a joining surface 7 of the retainer 4 and/or to the correspondence joining surface 8 on the inner side 27 of the housing 2, in particular the top shell 10 or the bottom shell 11, and/or the busbar holder 9.

In a third step S3, the joining surface 7 of the retainer 4 is joined onto the correspondence joining surface 8 optionally in order to produce permanent adhesion of the joining surface 7 to the correspondence joining surface 8 in order to fix the busbar 3 in the housing 2. Additionally or alternatively, a structure 12 of the retainer 4 is joined onto the correspondence structure 15 on the inner side 27 of the housing 2, in particular the top shell 10 or the bottom shell 11, and/or on the busbar holder 9 and optionally on the upper surface of the busbar 3. Optionally, the retaining region 5 of the retainer 4 is joined onto the busbar 3.

Optionally, in a fourth step S4, the top shell 10 and the bottom shell 11 are assembled to form the housing 2. As a result, the retainer 4 is optionally pressed against the busbar holder 9 by means of a mechanical tension created when the top shell 10 and the bottom shell 11 are joined together such that the respective busbar 3 is fixed in the housing 2 and/or the busbar holder 9 by means of the spacer 23.

Where applicable, all individual features which are illustrated in the exemplary embodiments can be combined with each other and/or exchanged without going beyond the scope of the invention.

### LIST OF REFERENCE SIGNS

1 busbar assembly
2 housing
3 busbar
4 retainer
5 retaining region
6 contact region
7 joining surface
8 correspondence joining surface
9 busbar holder
10 top shell
11 bottom shell
12 structure
13 elevation
14 depression
15 correspondence structure
16 correspondence elevation
17 correspondence depression
18 bore
19 slot
x longitudinal direction
y transverse direction
Z vertical direction
20 sink
21 diameter
22 bevel
23 spacer
24 gap
25 cavity
26 slope
27 inner side
28 screwed connection
29 rib
30 wall thickness
31 wall side
32 busbar side
33 tip
S1 first step
S2 second step
S3 third step
S4 fourth step

1. A retainer for fixing a busbar in a housing, comprising a retaining region which is adapted to retain a busbar, and a contact region which is adapted to fix the retainer in the housing, wherein a joining surface of the contact region is adapted to adhere to at least one of: a correspondence joining surface of the housing and/or to a busbar holder arranged in the housing.

2. The retainer according to claim 1, wherein the contact region has a structure comprising an elevation and a depression which is adapted to form a joined connection to a corresponding correspondence structure of the housing.

3. The retainer according to claim 2, wherein in particular the contact region comprises at least one of: a bore and/or a slot which is adapted to form with the correspondence structure, a corresponding correspondence elevation, the joined connection, wherein at least one of: the elevation and the depression comprises at least one of: the hole and the slot.

4. The retainer according to claim 2, wherein at least one of: the depression and the elevation has a variable wall thickness, a stepped wall thickness, in a vertical direction which is orthogonal to a longitudinal direction and a transverse direction, orthogonal to the longitudinal direction, of the busbar, wherein at least one of the depression and the elevation comprises a bevel.

5. The retainer according to claim 2, wherein at least one of: the depression and the elevation comprises, in the vertical direction, a sink and the bore and the slot, wherein at least one of: the sink and the bore and the slot has a different diameter in the vertical direction, wherein the diameter at least one of: increases and decreases as the depth increases in the vertical direction.

6. The retainer according to claim 2, wherein the joining surface is arranged at least one of: in the depression and on the elevation and comprises at least one of: the sink and the bore and the slot.

7. The retainer according to claim 6, wherein provided in the retaining region is a spacer which is at least one of: formed as a single piece with the retainer and at least from a material which is different from the retainer, a more elastic material than a material of the retainer, wherein at least one of: the spacer has a contact shape and a cavity and is adapted to press against the busbar for fixing it.

8. The retainer according to claim 7, wherein provided in the retaining region in the longitudinal direction of the busbar are at least two spacers, wherein the spacers are separated in the longitudinal direction by a gap and the gap is filled with a heat-dissipating medium.

9. The retainer according to claim 8, wherein at least one of: a slope is provided in the vertical direction with respect to a plane in the transverse direction and the retaining region has a thinner wall thickness than the contact region, in the transverse direction.

10. A housing for a busbar comprising a retainer, wherein the retainer comprises a retaining region and a contact region, wherein the retaining region is adapted to retain the at least one busbar in the housing and the contact region is adapted to fix the retainer in the housing, wherein the contact region of the retainer has a joining surface and the retainer is joined at the joining surface onto a corresponding correspondence joining surface on at least one of: an inner side of the housing and a busbar holder, arranged in the housing, for fixing the busbar and adheres to the correspondence joining surface by the joining surface.

11. The housing according to claim 10, wherein the retainer, the contact region of the retainer, has a structure, comprising at least one of: an elevation and a depression, which, with a correspondence structure which is arranged on at least one of: the inner side of the housing and on the busbar holder, corresponds with the structure of the retainer and comprises at least one of: a corresponding correspondence elevation and correspondence depression, forms a joined connection.

12. The housing according to claim 11, wherein the correspondence joining surface is arranged in at least one of: the correspondence depression and the correspondence elevation and in each case comprises at least one of: a sink and a bore and a slot.

13-14. (canceled)

15. A method for fixing at least one busbar by a retainer in a housing, comprising the steps:
moulding, foaming, the retainer onto at least one of: a correspondence joining surface of the housing and a correspondence structure on an inner side of the housing and a busbar holder in the housing; and
arranging at least the busbar in the housing and fixing it with the retainer.

16. A method for fixing a busbar by a retainer in a housing, comprising the steps:
arranging the at least one busbar at least one of: in the housing and on a busbar holder arranged in the housing;
applying a glue to at least one of: to a joining surface of the retainer and to a correspondence joining surface of the housing and on a busbar holder;
joining the joining surface of the retainer to the correspondence joining surface; and
fixing the busbar in the housing by the retainer.
